(19) United States
(12) Patent Application Publication
(10) Pub. No.: US 2010/0024166 A1
(43) Pub. Date: Feb. 4, 2010

(54) HINGE

(75) Inventor: SHIN-YUAN WANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/274,359

(22) Filed: Nov. 20, 2008

(30) Foreign Application Priority Data
Aug. 1, 2008 (CN) 200820301692.3

(51) Int. Cl. E05D 11/10

(52) U.S. Cl. 16/321; 16/319

(57) ABSTRACT

A hinge includes a rack, a shaft, and a bracket. The shaft includes a head with a stopper protruded thereon. A first side of the head is secured on the rack, and a second side of the head forms a post thereon. The bracket defines a pivoting hole. The bracket forms a restricting block adjacent the pivoting hole. The post is capable of rotating in the pivoting hole and the restricting block is capable of resisting against the stopper of the shaft to prevent the post from further rotating.

### CROSS-REFERENCE TO RELATED APPLICATION

Relevant subject matter is disclosed in a co-pending U.S. patent application (application Ser. No. 12/205,932; Attorney Docket No. US20954) filed on Sep. 8, 2008 and entitled “HINGE AND INTERFERENCE ASSEMBLY THEREOF”, which is assigned to the same assignee as this patent application. The disclosure of the co-pending application is incorporated herein by reference.

### BACKGROUND

1. Technical Field

The disclosure relates to mechanical structures and, particularly, to a hinge.

2. Description of Related Art

A collapsible device, such as a notebook computer or clamshell mobile phone, generally includes two parts pivotally connected via a hinge. The hinge generally includes a bracket mounted to one part and a shaft with one end mounted to the other part. The bracket includes a barrel rotatably receiving an opposite end of the shaft.

For protecting the collapsible device from damage caused by excessive rotation of the hinge, the hinge is usually equipped with two stop pieces to limit a rotating angle of the hinge. Each of the stop pieces includes a stop block. The stop pieces are retained around a shaft, and are capable of rotating about each other. One of the blocks is capable of being blocked by the other of the blocks, to limit the rotating angle between the stop pieces. However, the two stop pieces usually have complicated construction, and mounting the stop pieces to the shaft is troublesome.

Therefore, the present disclosure provides a hinge to obviate the described limitations.

### BRIEF DESCRIPTION OF THE DRAWINGS

FIGS. 1 and 2 are exploded, isometric views of an exemplary embodiment of a hinge, but viewed from two different perspectives, the hinge including a first interfering member and a second interfering member.

FIG. 3 is an enlarged view of the first interfering member and the second interfering member of the hinge of FIG. 1.

FIG. 4 is an assembled, isometric view of the hinge of FIG. 1.

### DETAILED DESCRIPTION

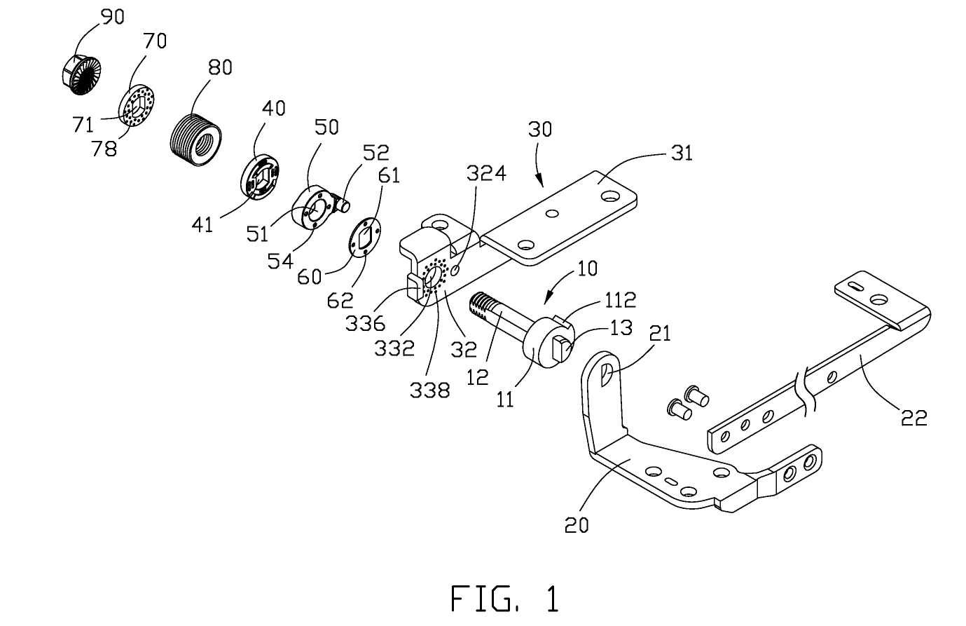

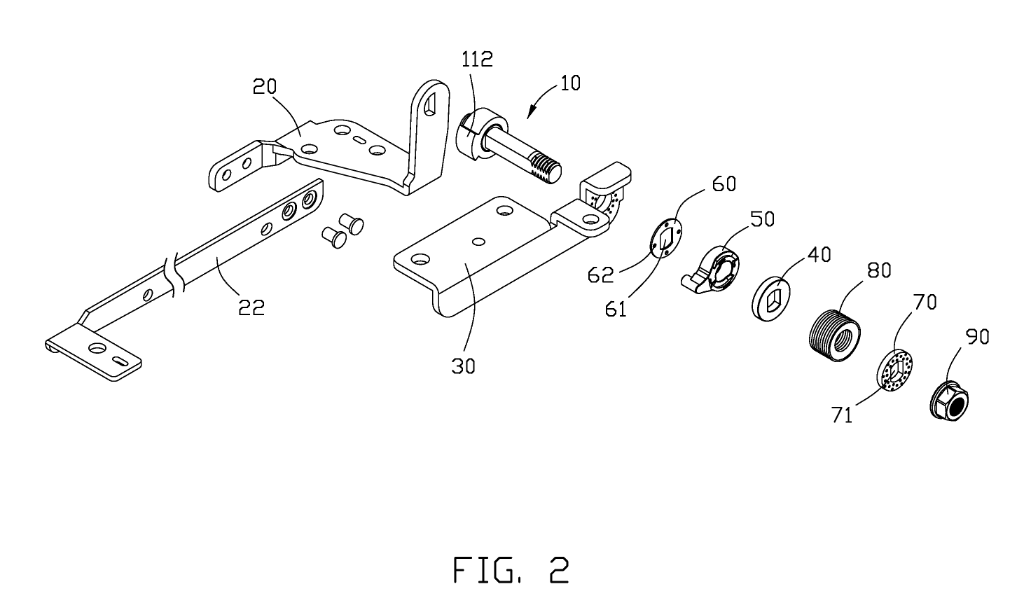

Referring to FIGS. 1 and 2, an exemplary embodiment of a hinge is adapted to be mounted to a collapsible device, such as a notebook or a clamshell mobile phone, that includes two parts rotatably connected to each other via the hinge. The hinge includes a shaft 10, a rack 20, a bracket 30, a first interfering member 40, a second interfering member 50, two washers 60 and 70, a resilient assembly 80, and a fastener 90.

The shaft 10 includes a generally cylindrical-shaped head 11, with a post 12 and an engaging portion 13 protruding from opposite sides of the head 11. A stopper 112 protrudes from a circumference of the head 11. The shaft 10 has a noncircular, such as double-D shaped, cross section. The distal end away from the head 11 of the shaft 10 forms a threaded portion. A cross section of the engaging portion 13 is semicircular to fix the shaft 10 to the rack 20. In other embodiments, the cross section of the engaging portion 13 may be any other shape that also enables the shaft 10 to be fixed to the rack 20.

The rack 20 includes a main body and a flange perpendicularly connected to an end of the main body. The flange defines a semicircular engaging hole 21 corresponding to the engaging portion 13. A plurality of securing holes are defined in the main body, for mounting the rack 20 to a leg 22 which is mounted to one part of the collapsible device.

The bracket 30 includes a main body 31 and a flange 32 perpendicularly extending from a side of the main body 31. The main body 31 defines a plurality of securing holes therein, for mounting the bracket 30 to the other part of the collapsible device. The flange 32 defines a round pivoting hole 332, for rotatably receiving the post 12 of the shaft 10. The flange 32 also defines a positioning hole 324 adjacent to the pivoting hole 332. A restricting block 336 is formed on the bracket 30, away from the positioning hole 324 and corresponding to the stopper 112 of the head 11. A distance between the restricting block 336 and the center of the pivoting hole 322 is equal to or smaller than a distance between the stopper 112 and the center of the head 11. A plurality of receiving holes 338 is defined in the flange 32, around the pivoting hole 332 for retaining lubricant.

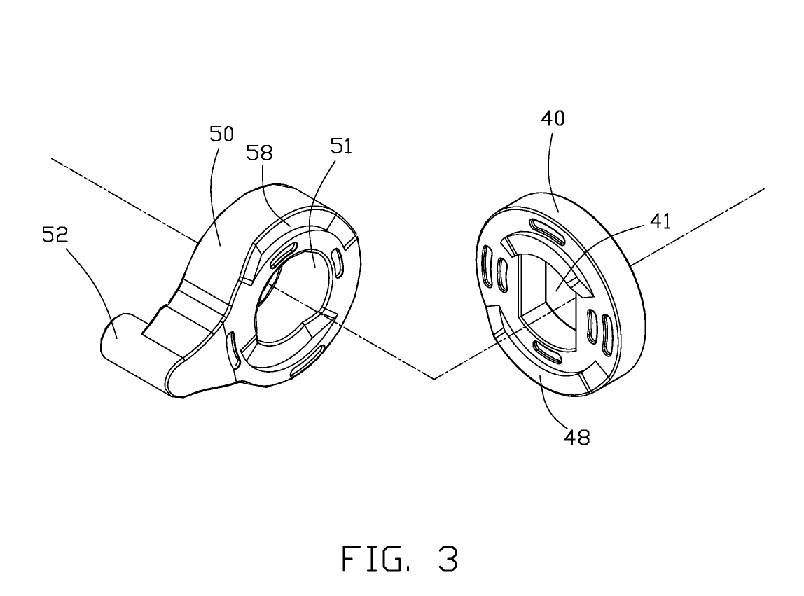

Referring to FIG. 3, the first interfering member 40 defines a double-D shaped through hole 41, corresponding to the post 12 of the shaft 10, configured to snugly fit about the post 12. A side of the first interfering member 40 facing the second interfering member 50 forms a first engaging portion 48, such as a protrusion in the illustrated embodiment.

The second interfering member 50 defines a round through hole 51, for rotatably receiving the post 12. A side of the second interfering member 50 facing the first interfering member 40 forms a second engaging portion 58, such as a depressed portion in the illustrated embodiment, to engage with the first engaging portion 48 of the first interfering member 40. An inserting portion 52 is formed on a circumference of the second interfering member 50, for being inserted into the positioning hole 324 to fix the second interfering member 50 to the bracket 30. A plurality of salient points 54 are formed on a side opposite to the first interfering member 40 of the second interfering member 50, to increase friction between the second interfering member 50 and the washer 60 when the hinge rotates.

The washer 60 defines a double-D shaped through hole 61, to snugly fit about the post 12. A side of the washer 60 facing the second interfering member 50 forms a plurality of salient points 62, to increase friction between the second interfering member 50 and the washer 60. An opposite side of the washer 60 forms a plurality of salient points 62, to increase friction between the washer 60 and the flange 32 of the bracket 30 when the hinge rotates.

The washer 70 defines a double-D shaped through hole 71, to snugly fit about the post 12. Opposite sides of the washer 70 define a plurality of receiving holes 78, for retaining lubricant.

In one embodiment, the resilient assembly 80 includes a plurality of resilient frictional washers. These washers are stacked together, and rotationally retained around the post 12. In an alternative embodiment, the resilient assembly 80 can be a spring or other resilient component. In one embodiment, the fastener 90 is a hexagonal nut, and can be screwed to the threaded portion of the post 12.

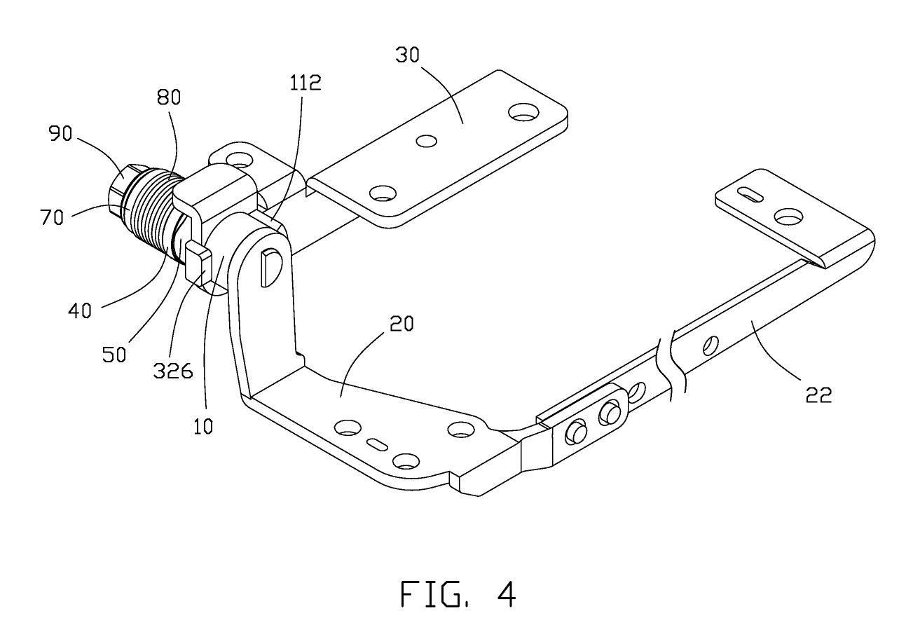

Referring to FIGS. 1 to 4, in assembly, the engaging portion 13 of the shaft 10 is inserted into the engaging hole 21 of the rack 20. The post 12 of the shaft 10 is inserted through the pivoting hole 332 of the bracket 30, the through hole 61 of the washer 60, the through hole 51 of the second interfering member 50, the through hole 41 of the first interfering member 40, the resilient assembly 80, and the through hole 71 of the washer 70 orderly, to be screwed to the fastener 90. The inserting portion 52 of the second interfering member 50 is inserted into the positioning hole 324 of the bracket 30. The second engaging portion 58 of the second interfering member 50 is engaged with the first engaging portion 48 of the first interfering member 40.

In use, the shaft 10 rotates in the pivoting hole 332 of the bracket 30. After the shaft 10 rotates an angle, the restricting block 336 of the bracket 30 resists against the stopper 112 of the shaft 10 to prevent the shaft 10 from further rotating.

While several embodiments have been disclosed, it is understood that any element disclosed in any one embodiment is easily adapted to other embodiments. It is also to be understood, however, that even though numerous characteristics and advantages of the disclosure have been set forth in the foregoing description, together with details of the structure and function of the invention, the disclosure is illustrative only, and changes may be made in details, especially in matters of shape, size, and arrangement of parts within the principles of the invention to the full extent indicated by the broad general meaning of the terms in which the appended claims are expressed.

1-10. (canceled)

11. A hinge, comprising:
a rack with a shaft fixed thereto, the shaft comprising a head and a post whose cross section is noncircular, a stopper formed on the shaft;
a bracket defining a pivoting hole for rotatably receiving the post therein, the bracket forming a restricting block to prevent the post from further rotating when the stopper resists against the restricting block, a plurality of receiving holes defined in the bracket around the pivoting hole for retaining lubricant;
a first interfering member defining a through hole to snugly fit about the post to allow the first interfering member to rotate with the post;
a second interfering member mounted to the bracket, the second interfering member is capable of engaging with the first interfering member to optimize the rotation of the post of the shaft in the pivoting hole of the bracket;
a resilient assembly rotatably retained around the post;
a first washer;
a second washer defining a noncircular through hole to snugly fit about the post; and
a fastener;
wherein the post of the shaft is inserted through the pivoting hole of the bracket, the first washer, the second interfering member, the first interfering member, the resilient assembly, and the noncircular through hole of the washer orderly, to be screwed to the fastener, the head of the shaft is in tight contact with the bracket.

12. (canceled)

13. The hinge of claim 11, wherein the resilient assembly comprises a plurality of resilient frictional washers, these washers are stacked together and rotationally retained around the post.

14. The hinge of claim 11, wherein opposite sides of the second washer define a plurality of receiving holes for retaining lubricant.

15. The hinge of claim 11, wherein the bracket defines a positioning hole, the second interfering member forms an inserting portion inserted into the positioning hole to fix the second interfering member to the bracket.

16. The hinge of claim 11, wherein the first interfering member forms a first engaging portion, the second interfering member forms a second engaging portion capable of engaging with the first engaging portion.

17. The hinge of claim 11, wherein the second interfering member defines a round through hole, the post is rotatably inserted through the through hole of the second interfering member.

18. (canceled)

19. The hinge of claim 11, wherein the first washer defines a noncircular through hole to snugly fit about the post, and opposite sides of the first washer form a plurality of salient points configured to increase friction when the washer rotates.

20. The hinge of claim 11, wherein the side of the head secured to the rack forms an engaging portion whose cross section is semicircle-shaped, the rack defines a semicircle-shaped engaging hole for receiving the engaging portion.
